(19) United States
(12) Patent Application Publication
(10) Pub. No.: US 2017/0130935 A1
(43) Pub. Date: May 11, 2017

(54) OPTICAL LENS AND A SPOTLIGHT INCLUDING THE SAME

(71) Applicant: Xu Hong, San Jose, CA (US)

(72) Inventor: Xu Hong, San Jose, CA (US)

(21) Appl. No.: 14/937,761

(22) Filed: Nov. 10, 2015

(51) Int. Cl. F21V 13/04; F21V 7/04; F21V 7/00; F21V 5/04

(52) U.S. Cl. CPC F21V 13/04; F21V 5/04; F21V 5/048; F21V 7/048; F21V 7/0066; F21Y 2115/10

(57) ABSTRACT

A conical frustum shaped optical lens is made of transparent material, the conical frustum shaped optical lens having a long diameter at a first end and a short diameter at a second end and the conical frustum shaped optical lens defined by multiple rotational surfaces and a flat fifth surface. The conical frustum shaped optical lens is configured to create folded light paths within the conical frustum shaped optical lens such that a majority of light from a light source is reflected twice within the conical frustum shaped optical lens before being output. An MR16 form factor LED spotlight including the conical frustum shaped optical lens can achieve a reduced light beam angle and a higher central luminous intensity.

### TECHNICAL FIELD

The present application relates to the field of spotlights and, more specifically, to an optical lens and a spotlight including the same.

### BACKGROUND

Light-emitting diode (LED) based lamps can save a significant amount of energy than both fluorescent lamps and incandescent lamps for producing the same amount of luminous flux. Because of this advantage, people have been trying to replace the conventional light sources with LED chips in many lamp applications including spotlights. Conventional optical lenses used for spotlights usually have a single curved reflection surface for increasing the central luminous intensity of a region targeted by a spotlight. But because there are industry standards limiting the total volume of a spotlight, it has been a challenge for, e.g., a multifaceted-reflector (MR) 16 form factor LED-based spotlight using one of the conventional optical lenses to achieve the same level of light beam angle and high luminous intensity at the center of a lighted region as an MR16 form factor halogen-based spotlight, which unfortunately consumes much more energy than LED-based spotlights.

### SUMMARY

The above deficiencies and other problems associated with the conventional spotlight lens design are reduced or eliminated by the present application disclosed below.

One aspect of the present application involves a conical frustum shaped optical lens made of transparent material, the conical frustum shaped optical lens having a long diameter at a first end and a short diameter at a second end and the conical frustum shaped optical lens defined by multiple rotational surfaces and a flat fifth surface.

In some embodiments, the multiple rotational surfaces include a first surface, a second surface, a third surface, and a fourth surface. The conical frustum shaped optical lens has a cavity located near the second end and defined by the first surface and the second surface for engaging a light source. The first surface is configured such that at least a portion of light striking the first surface from the light source is refracted by the first surface onto the flat fifth surface. The second and third surfaces are configured such that a first portion of light striking the second surface from the light source is refracted by the second surface onto the third surface and then reflected by the third surface onto the flat fifth surface. The second and fourth surfaces are configured such that a second portion of light striking the second surface from the light source is refracted by the second surface onto the flat fifth surface and then entirely reflected by the flat fifth surface onto the fourth surface and then reflected by the fourth surface back onto the flat fifth surface.

In some embodiments, the first surface includes a conical frustum portion and a spherical portion and it is configured to refract at least a portion of the light onto the flat fifth surface at an incidence angle of not great than 4-degree.

In some embodiments, the second surface includes a first multifaceted portion near the bottom of the cavity and the first multifaceted portion is configured to refract, partially, the second portion of the light onto the flat fifth surface at an incidence angle greater than a critical angle between the transparent material and the air. The second surface further includes a second multifaceted portion near the opening of the cavity and the second multifaceted portion is configured to refract, partially, the second portion of the light onto the third surface at an incidence angle greater than a critical angle between the transparent material and the air.

In some embodiments, the fourth surface is covered with a reflective coating. The conical frustum shaped optical lens is made from a UV-resistant transparent material selected from the group consisting of glass and polycarbonate material.

In some embodiments, the conical frustum shaped optical lens is used in an MR16 form factor spotlight.

Another aspect of the present application involves a spotlight including the conical frustum shaped optical lens described above. The spotlight further includes a lens support made of plastic material and an LED chip.

In some embodiments, the lens support has a top surface covered with a reflective coating and the top surface is configured to tightly engage the fourth surface of the conical frustum shaped optical lens. In some embodiments, the spotlight is an MR16 form factor spotlight.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

In order to explain the embodiment of the present application and the technical scheme of conventional technology more clearly, the following will briefly introduce the necessary drawings described in the embodiment or conventional technology, obviously, the drawings in the following description are only some embodiments of the present application, for the common technicians of this field, they can also obtain other drawings according to these drawings without any creative labor.

FIG. 1 is an exploded schematic view of an LED spotlight including an optical lens, a lens support, and an LED chip according to some embodiments of the present application;

FIGS. 2A through 2D are multiple perspective schematic views of the optical lens and the lens support according to some embodiments of the present application;

FIG. 3 is a cross-sectional schematic view of the optical lens according to some embodiments of the present application;

FIGS. 4A through 4D are multiple cross-sectional schematic views illustrative of different light paths in the optical lens according to some embodiments of the present application;

FIG. 5 is a cross-sectional schematic view of dimensions of the optical lens according to some embodiments of the present application; and

FIGS. 6A and 6B are cross-sectional schematic views illustrative of dimensional constraints over certain portions of the optical lens according to some embodiments of the present application.

Like reference numerals refer to corresponding parts throughout the several views of the drawings.

### DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In the following, combined with the attached drawings of the embodiment of the present application, the technical scheme of the embodiment of the present application will be described clearly and entirely, obviously, the described embodiments are only some of the embodiments, not all of them. Based on the embodiment of the present application, all the other embodiments obtained by the common technicians of this field without any creative labor belong to the protective scope of the present application.

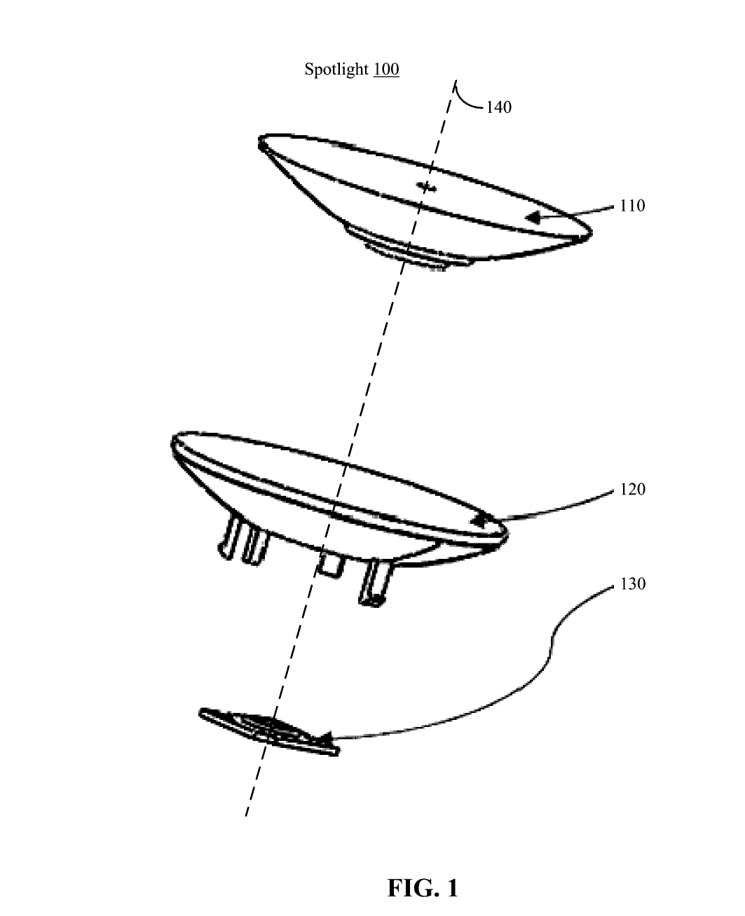

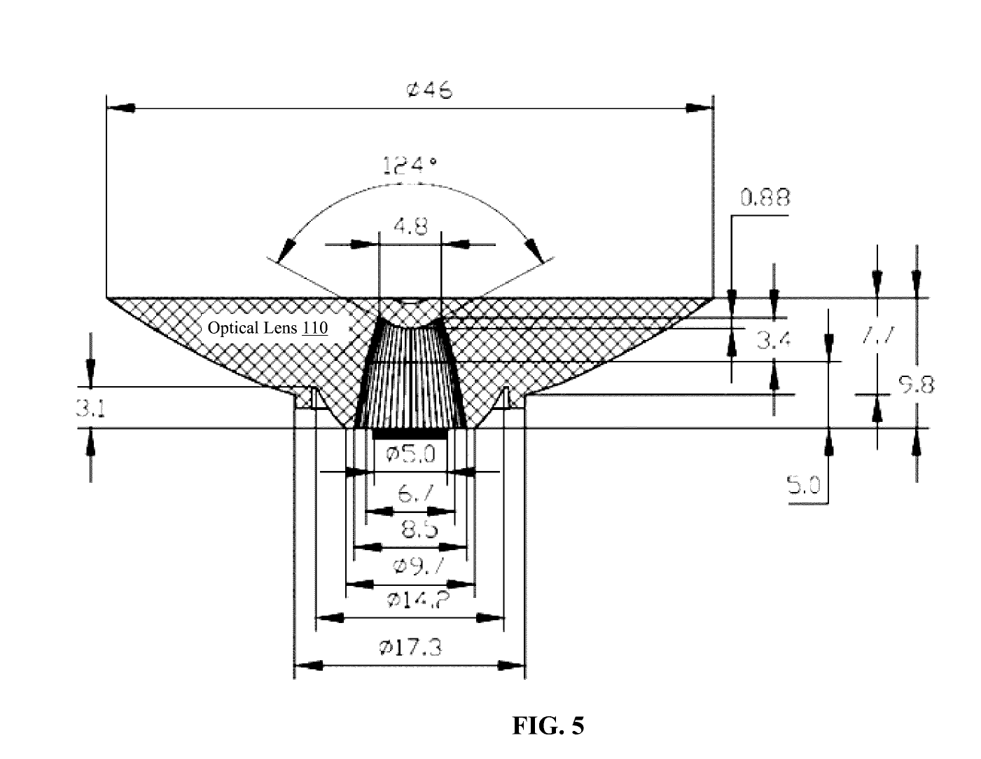

FIG. 1 is an exploded schematic view of an MR16 form factor LED spotlight 100 including an optical lens 110, a lens support 120, and an LED chip 130 according to some embodiments of the present application. FIG. 5 is a cross-sectional schematic view of various dimensions of the optical lens 110 according to some embodiments of the present application. As shown in the two figures, the optical lens 110 has a conical frustum shaped optical lens having a long diameter at its top surface and a short diameter at its bottom. For example, the long diameter of an optical lens used in the MR16 form factor LED spotlight is 46.0 mm and the short diameter of the optical lens is 9.7 mm. The height of the optical lens is 9.8 mm. In some embodiments, the optical lens 110 is made from a UV-resistant transparent material, such as glass, polycarbonate material, or the like. For example, LEV 170 is a transparent polycarbonate (PC) material made by Idemitsu Kosan of Japan with a refractive index of 1.59 relative to the air that can be used for forming the optical lens of the present application.

As shown in FIG. 1, the optical lens 110 sits on top of the lens support 120. At the bottom of the optical lens 110 is a cavity for engaging the LED chip 130 such that light from the LED chip 130 passes through the optical lens 110 and exits the optical lens 110 from its top flat surface. The lens support 120 is typically made of plastic materials that can sustain a temperature of 100° C. or higher. In some embodiments, the lens support 120 has a reflective coating on its top surface that tightly engages the bottom surface of the optical lens 110 for reflecting light back to the top surface of the optical lens 110. In other words, folded light paths are created within the optical lens 110 such that a majority of light from the LED chip 130 is reflected twice within the optical lens 110 before being output. As a result, the spotlight 100 can achieve a tighter columniation of light than is normally available from a conventional lamp design of equivalent depth. In some embodiments, the LED chip 130 has a circular lighting surface of 5.0 mm in diameter and a light beam angle of 120-degree. The circular lighting surface is located on the same surface as the bottom of the optical lens 110. The optical lens 110, the lens support 120, and the LED chip 130 are centered along the axis 140 with their top surfaces being perpendicular to the axis 140, respectively. For an 8W MR16 form factor LED spotlight having an optical lens made of LEV 170 PC material, the spotlight can achieve a light beam angle of 8-degree and a central luminous intensity of approximately 10,000 candela (cd).

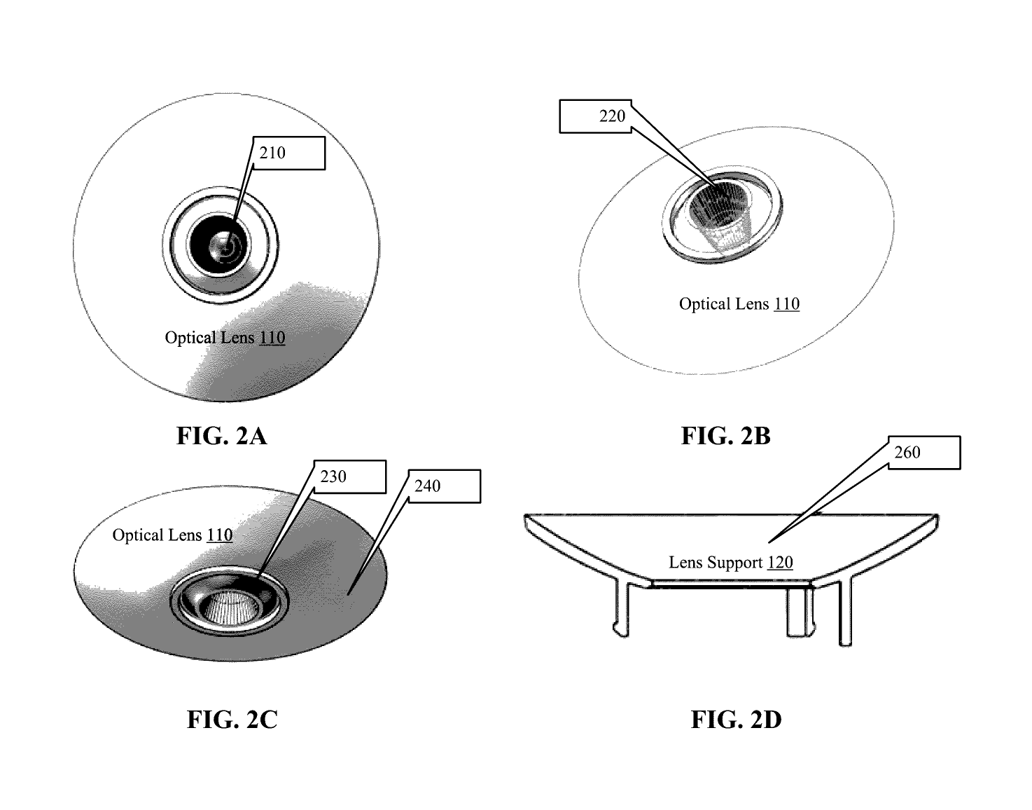

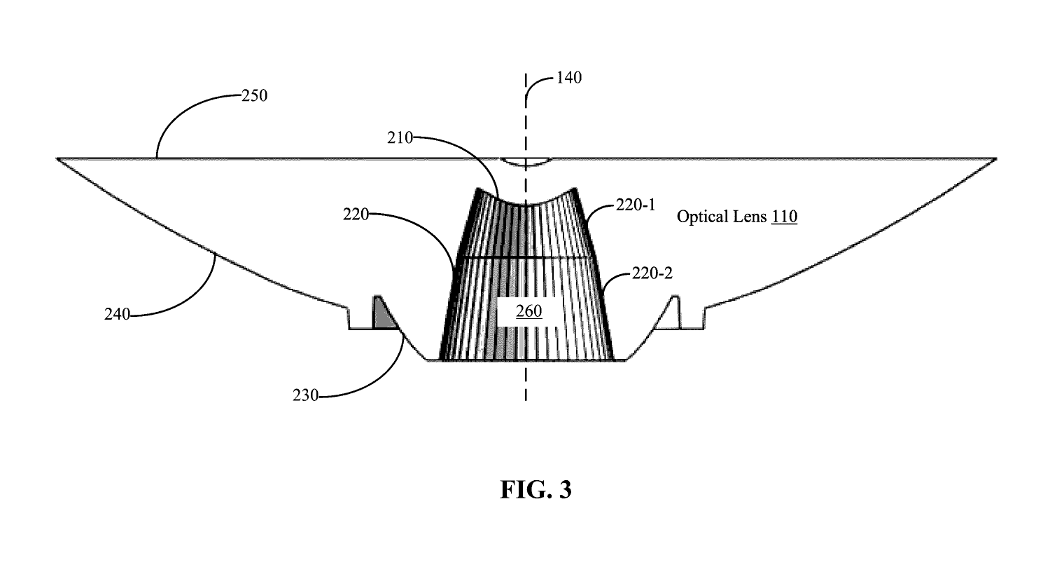

The reason that an LED spotlight including an optical lens disclosed herein can significantly increase the central luminous intensity lies in the fact that the optical lens has a conical frustum shaped optical lens with multiple surfaces for redirecting light from the LED chip towards virtually the same direction. FIGS. 2A through 2D are multiple perspective schematic views of the optical lens 110 and the lens support 120 according to some embodiments of the present application. As shown in FIG. 2A, the conical frustum shaped optical lens has a cavity with an opening near the bottom of the lens body. The bottom of the cavity is a curved surface 210 for collecting some light from the LED chip located near the opening of the cavity (not shown in FIG. 2A). FIG. 2B depicts the surrounding surface 220 of the cavity. As will be explained below in more detail, its shape is very important for achieving the high central luminous intensity described above. FIG. 2C depicts two bottom surfaces 230 and 240 of the conical frustum shaped optical lens. The surface 230 is closer to the surface 220 than the surface 240. Both surfaces are responsible for reflecting incident light onto the top surface of the optical lens (not shown in FIG. 2C). Finally, FIG. 2D depicts a portion of a lens support supporting the optical lens as shown in FIG. 1. The lens support has a surface 260 that engages the surface 240 of the optical lens seamlessly. In some embodiments, at least one of the surface 260 and the surface 240 is covered with a reflective coating for reflecting incident light.

FIG. 3 is a 2-D cross-sectional schematic view of the optical lens 110 according to some embodiments of the present application. As described above in connection with FIGS. 1 and 2A-2C, the optical lens 110 has a conical frustum shaped optical lens with a cavity 260 near its bottom. The conical frustum shaped optical lens is defined by multiple rotational surfaces and a flat top surface 250. As shown in FIG. 3, the multiple rotational surfaces include a surface 210 and a surface 220 that collectively define the cavity 210 (which is open-ended) and a surface 230 and a surface 240 defining the bottom surface of the optical lens 110. As will be described below in more detail, some light from an LED chip located near the opening of the cavity 260 (not shown in FIG. 3) strikes the surface 210, which is then refracted onto the top surface 250 and then out of the optical lens 110 in a small angle relative to the central axis 140 (e.g., less than 5-degree). Some light from the LED chip strikes the surface 220, which is then refracted onto the surface 230 or the top surface 250. The light refracted onto the surface 230 is then refracted out of the optical lens 110 in a small angle relative to the central axis 140.

By carefully designing the shape and dimension of the surface 220, a significant portion of light refracted by the surface 220 strikes the top surface 250 at an angle greater than the critical angle of the material used for making the optical lens (e.g., LEV 170). When a propagating wave (including light) within a first medium strikes a boundary between the first medium and a second medium at an angle larger than a particular critical angle with respect to the normal to the boundary, a phenomenon called “total internal reflection” occurs. In particular, if the refractive index of the first medium (e.g., LEV 170) is greater than that of the second medium (e.g., air) on the other side of the boundary, the wave whose incidence angle is greater than the critical angle cannot pass through the boundary and is entirely reflected. In the present case, a majority of light striking the top surface at an angle greater than the critical angle of the material used for making the optical lens is entirely reflected onto the surface 240. By carefully designing the shape and dimension of the surface 240, most of the light is reflected back onto the top surface 250 at an angle much smaller than the critical angle. Such light is then refracted out of the top surface 250 at a small angle (e.g., no greater than 5-degree) relative to the central axis 140. In sum, when different portions of the optical lens 110 have predefined shapes and dimensions, light emitted by the LED chip, enters into the optical lens 110 through different surfaces, is reflected once or multiple times inside the conical frustum shaped optical lens, and finally exits the optical lens 110 from its top surface 250 at a relatively small angle with respect to the central axis 140.

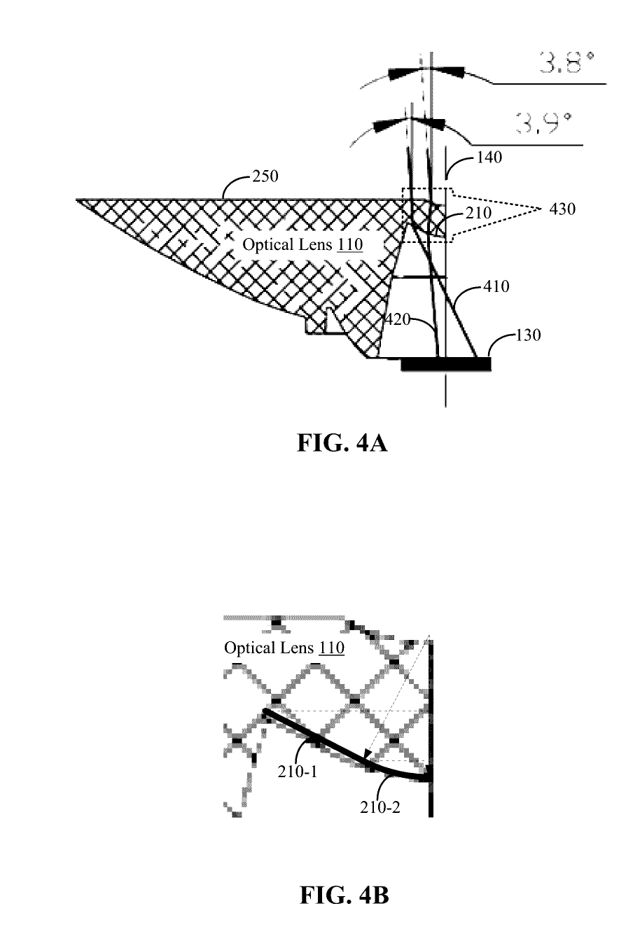

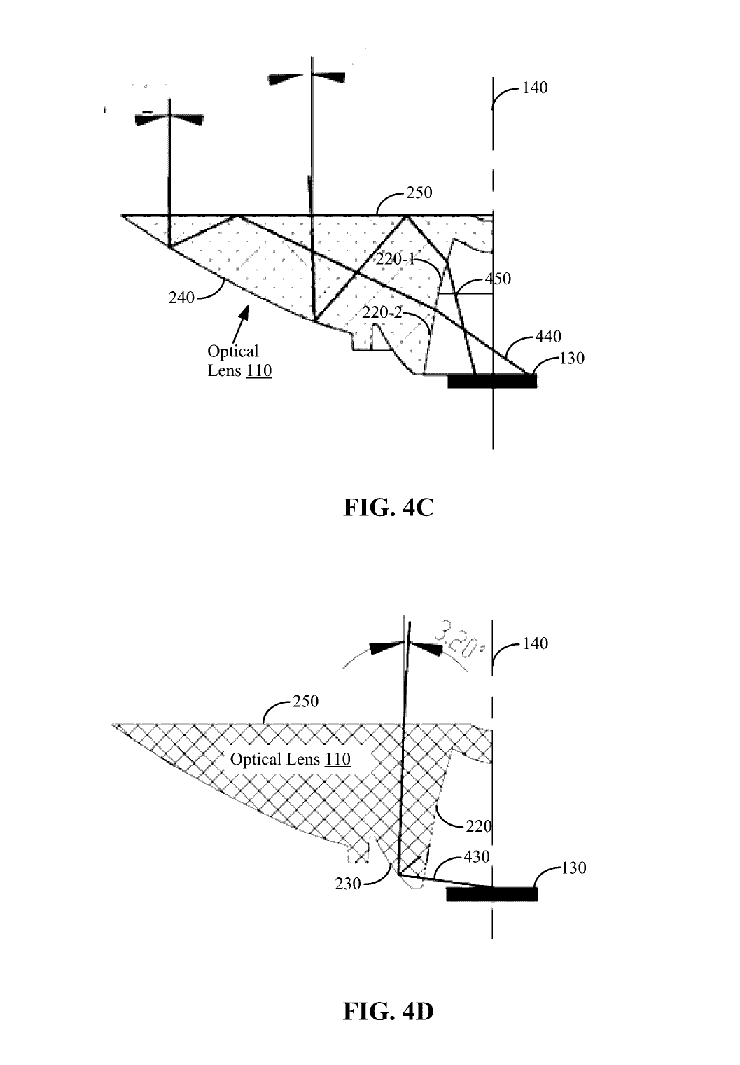

In order to better describe the functionalities of the optical lens 110, FIGS. 4A through 4C depict multiple cross-sectional schematic views of representative light paths in the optical lens 110 according to some embodiments of the present application. Since the optical lens 110 has a conical frustum shaped optical lens, only the left half of the lens body is depicted in FIGS. 4A through 4D for brevity. One skilled in the art would understand that the right half of the lens body is symmetrical to the left half with respect to the central axis 140.

In particular, FIG. 4A depicts two light paths 410 and 420 from the LED chip 130. Note that the two light paths strike the surface 210 at two different incidence angles. For example, the incidence angle of the light path 410 (which is probably the largest among all the light paths striking the surface 210) is significantly greater than that of the light path 420 (which is close to the smallest incidence angle among all the light paths striking the surface 210). However, when both light paths exit the top surface 250 of the optical lens 110, they almost have the same angle with respect to the central axis 140. For example, the angle between the light path 410 and the central axis 140 (or its parallel line) is 3.9-degree and the angle between the light path 420 and the central axis 140 (or its parallel line) is 3.8-degree.

In some embodiments, it is estimated that approximately 7% of the light from the LED chip 130 strikes the surface 210 at different incidence angles and is then refracted away from the surface 210 at different refraction angles. In order to have a small light beam angle for the light paths striking the optical lens 110 at the surface 210 and departing from the optical lens 110 at the top surface 250, the surface 210 is configured to be comprised of two portions as shown in FIG. 4B, which is an enlarged view of the portion 430 in FIG. 4A. As shown in FIG. 4B, the surface 210 includes a conical frustum portion 210-1 and a spherical portion 210-2. As shown in FIG. 5, the conical frustum portion 210-1 has a conical angle of 124-degree and a diameter of 4.8 mm at its top. The spherical portion 210-2 has a diameter of 3.0 mm. The total volume of the surface 210 is 4.8 mm×4.8 mm×0.88 mm. For a spotlight having an optical lens 110 with such shape and dimension configuration for the surface 210, it is estimated that approximately 3% of the central luminous intensity may be contributed by light striking the surface 210.

Because of the area difference between the surface 210 and the surface 220, a majority of light from the LED chip 130 strikes the surface 220, not the surface 210. In some embodiments (as shown in FIGS. 3 and 5), the surface 220 is comprised of two conical frustum portions 220-1 and 220-2. The conical frustum portion 220-1 has a diameter of 4.8 mm at its top, a diameter of 6.7 mm at its bottom, a height of 3.4 mm, and a conical angle of 32-degree. The conical frustum portion 220-2 has a diameter of 6.7 mm at its top, a diameter of 8.5 mm at its bottom, a height of 5.0 mm, and a conical angle of 20-degree. In some embodiments, each of the two conical frustum portions is approximated by a plurality (e.g., 50) of facets, each facet is a small flat surface (not a curved surface). These facets provide optical control by gathering the light from different directions to create a concentrated light beam. It should be noted that the shape and dimension of the surface 220 as described above is only for illustrative purpose.

FIG. 4C depicts that two light path 440 and 450 depart from different parts of the LED chip 130 at different angles. The light path 440 first strikes the lower portion 220-2 of the surface 220 and is then reflected by the top surface 250 and the surface 240 and finally departs from the top surface 250 in a nearly vertical direction (0.71-degree). Similarly, the light path 450 first strikes the upper portion 220-1 of the surface 220 and is then reflected by the top surface 250 and the surface 240 and finally departs from the top surface 250 at a small refraction angle (4-degree). As shown in FIG. 5, the top surface 250 has a diameter of 46 mm. Assuming that the refraction index of the material (e.g., LEV 170) for making the optical lens 110 is 1.59, the critical angle at the top surface is therefore arcsin(1/1.59)≈39-degree. In other words, it is likely that a lot of light paths like the light path 430 are entirely reflected because their incidence angles are greater than 39-degree. In other words, there is very little light passing through the top surface 250 when it is refracted onto the top surface 250 by the surface 220. The surface 240 is a special curved rotational surface such that it can reflect most of the light paths reflected by the top surface 250 like the light paths 440 and 450 onto the top surface with a small incidence angle, which is important for reducing the spotlight's light beam angle and increasing the central luminous intensity.

In some embodiments, it is estimated that approximately 63% of the light from the LED chip 130 follow the light paths similar to the light paths 440 and 450. Therefore, the light that is twice reflected by the top surface 250 and the surface 240 makes the primary contribution to the high central luminous intensity. For example, it is estimated that approximately 94% of the central luminous intensity may be contributed by light that is twice reflected between the top surface 250 and the surface 240 before being output.

FIG. 4D depicts a light path 430 that first strikes the surface 220 and is then reflected by the surface 230 onto the top surface 250. The light path 430 has a near zero incidence angle on the top surface 250 and a refraction angle of 3.2-degree when departing from the top surface 250. As shown in FIG. 5, the surface 230 is a special curved rotation surface. In some embodiments, the surface 230 has a diameter of 12.2 mm at its top, a diameter of 9.7 mm at its bottom and a height of 3.1 mm. It is estimated that approximately 26% of the light from the LED chip 130 follows the light path that is similar to the light path 430, which contributes approximately 3% of the central luminous intensity.

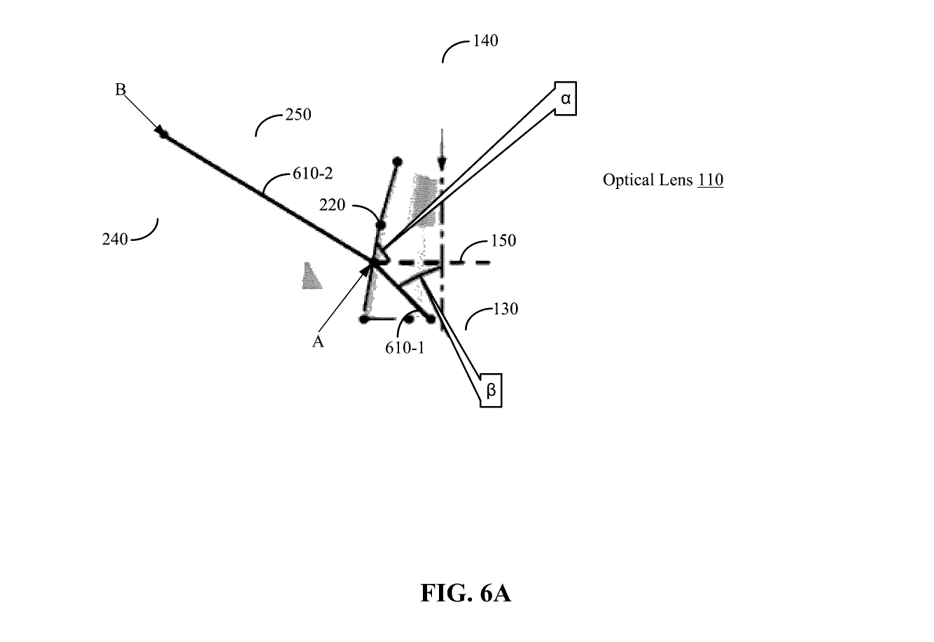

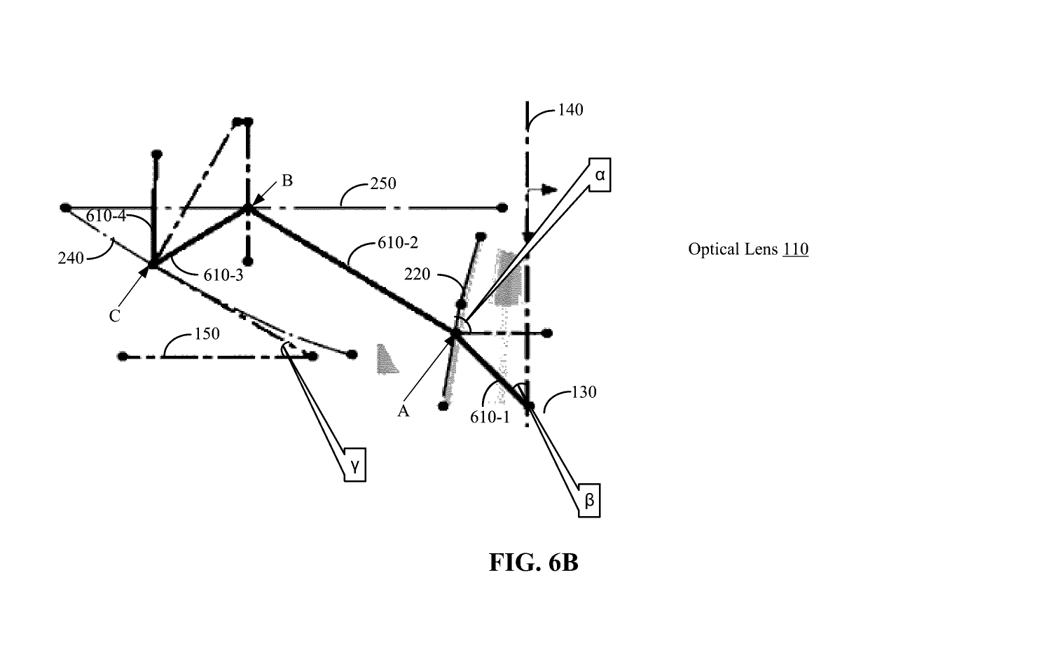

Note that the shape and dimension parameters described above are for illustrative purposes. For example, the surface 220 does not have to be comprised of two conical frustum portions as shown in FIG. 4C. It can be in the form of a curved rotational surface like the surfaces 230 and 240 or other shapes. In some embodiments, the surface 220 may need to satisfy certain geometry constraints in order to achieve a small light beam angle and a high central luminous intensity. FIG. 6A depicts one light path 610 originating from the LED chip 130 and striking the top surface 250 at an angle above the critical angle. As shown in the figure, the light path 610 has two segments 610-1 and 610-2. The segment 610-1 is located within the cavity before striking the surface 220 at the point A. The segment 610-2 is located within the optical lens 110 and between the point A on the surface 220 and the point B on the surface 250.

Assuming that the angle between the segment 610-1 and the central axis 140 is denoted as β and the angle between the trajectory of the surface 220 at the point A and the horizontal axis 150 (which is perpendicular to the central axis 140) is denoted as α, it is estimated that the light path 610 strikes the top surface 250 at an angle above the critical angle when the two angles satisfy the following constraints:

α>arcsin(sin(α-β)/n)+arcsin(1/n),
where n is the refraction index of the material for making the optical lens. For example, if n=1.59 and β=15-degree, the trajectory of the surface 220 at the point A should form an angle with the horizontal axis 150 between 73-degree and 90-degree in order for the corresponding light path to strike the top surface 250 at an angle above the critical angle. As noted above, the twice-reflected light between the top surface 250 and the surface 240 contributes more than 90% of the central luminous intensity. The formula above ensures that light should strike the top surface 250 at an angle above the critical angle to the extent possible. Once the light is entirely reflected by the top surface 250, the shape and curvature of the surface 240 should be carefully designed such that light should be reflected back to the top surface 250 to the extent possible.

FIG. 6B depicts that the light path 610 after the first total internal reflection by the top surface 250 at point B. As shown in the figure, the light path 610 is reflected by the surface 240 at the point C back to the top surface 250 and then refracted out of the optical lens 110. The light path associated with the second reflection within the optical lens 110 also has two segments 610-3 and 610-4. The segment 610-3 is located within the optical lens 110 and between the point B on the surface 250 and the point C on the surface 240. The segment 610-4 is located within the optical lens 110 and between the point C on the surface 240 and the surface 250.

Assuming that half of the light beam angle of the spotlight including the optical lens 110 is denoted as θ and the angle between the trajectory of the surface 240 at the point C and the horizontal axis 150 is denoted as γ, γ should satisfy the following constraint in order for θ to meet the desired value:

-arcsin(sinθ/n)≦2γ-(α-arcsin(sin(α-β)/n))≦arcsin(sinθ/n),
where n is the refraction index of the material for making the optical lens and α and β have the same definition as described above in connection with FIG. 6A. For example, if n=1.59, α=74-degree, β=30-degree, and θ=4-degree (in other words, the desired light beam angle for the spotlight is 8-degree), it can be determined that γ should be between 22.8-degree and 25.3-degree.

Embodiments of the present application include an MR16 form factor spotlight. An LED chip includes from 20 to 110 LEDs arrayed in series upon a thermally conductive substrate. The substrate is soldered to a flexible printed circuit substrate (FPC) having a pair of input power connectors. The silicon substrate is physically bonded to an MR16 form factor heat sink via thermal epoxy. A driving module including a high-temperature operating driving circuit is attached to a rigid printed circuit board or a flexible printed circuit substrate. Both the driving circuit and FPC are encased in a thermally conductive plug base that is compatible with an MR16 plug, forming the base assembly module. A potting compound facilitating heat transfer from the driving circuit to the thermally conductive plug case is typically used. The driving circuits are coupled to input power contacts (e.g. 12, 24, 120, 220 volt AC) and coupled to output power connectors (e.g. 40 VAC, 120 VAC, etc.) The base assembly module is inserted into and secured within an interior channel of the MR16 form factor heat sink. The input power connectors are coupled to the output power connectors. An optical lens according to the present application is then secured to the heat sink.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. An optical lens, comprising
A transparent material forming a conical frustum shaped optical lens, said lens having a long diameter at a first end and a short diameter at a second end and the conical frustum shaped optical lens defined by multiple rotational surfaces and a flat fifth surface, the multiple rotational surfaces including a first surface, a second surface, a third surface, and a fourth surface,
a cavity located near the second end and defined by the first surface and the second surface for engaging a light source, wherein
the first surface is configured such that at least a portion of light striking the first surface from the light source is refracted by the first surface onto the flat fifth surface;
the second and third surfaces are configured such that a first portion of light striking the second surface from the light source is refracted by the second surface onto the third surface and then reflected by the third surface onto the flat fifth surface; and
the second and fourth surfaces are configured such that a second portion of light striking the second surface from the light source is refracted by the second surface onto the flat fifth surface and then entirely reflected by the flat fifth surface onto the fourth surface and then reflected by the fourth surface back onto the flat fifth surface.

2. The lens of claim 1, wherein the first surface is configured to refract at least a portion of the light onto the flat fifth surface at an incidence angle of not great than 4-degree.

3. The lens of claim 2, wherein the first surface further includes a conical frustum portion and a spherical portion.

4. The lens of claim 1, wherein the second surface includes a first multifaceted portion near the bottom of the cavity and the first multifaceted portion is configured to refract, partially, the second portion of the light onto the flat fifth surface at an incidence angle greater than a critical angle between the transparent material and the air.

5. The lens of claim 4, wherein the second surface further includes a second multifaceted portion near the opening of the cavity and the second multifaceted portion is configured to refract, partially, the second portion of the light onto the third surface at an incidence angle greater than a critical angle between the transparent material and the air.

6. The lens of claim 1, wherein the conical frustum shaped optical lens has a central axis and a horizontal axis that is perpendicular to the central axis, the second surface is configured to satisfy the following constraints:
α>arcsin(sin(α-β)/n)+arcsin(1/n),
wherein β is an angle between a light path within the cavity and the central axis, α is an angle between a trajectory of the surface at a point where the light path strikes the second surface and the horizontal axis, and n is a refraction index of a material forming the conical frustum shaped optical lens.

7. The lens of claim 6, wherein the light path within the conical frustum shaped optical lens strikes the flat fifth surface at an angle no less than a critical angle defined by the refraction index of a material forming the conical frustum shaped optical lens.

8. The lens of claim 6, wherein the fourth surface is configured to satisfy the following constraints:
-arcsin(sinθ/n)≦2γ-(α-arcsin(sin(α-β)/n))≦arcsin(sinθ/n),
wherein θ is a half of a predefined light beam angle and γ is an angle between a trajectory of the fourth surface at a point where the light path strikes the fourth surface and the horizontal axis.

9. The lens of claim 1, wherein the fourth surface is covered with a reflective coating.

10. The lens of claim 1, wherein the conical frustum shaped optical lens is used in a multifaceted-reflector (MR) 16 form factor spotlight.

11. The lens of claim 1, wherein the conical frustum shaped optical lens is made from a UV-resistant transparent material selected from the group consisting of glass and polycarbonate material.

12. A spotlight comprising:
a lens support made of a plastic material;
a conical frustum shaped optical lens made of transparent material and secured on top of the lens support, the conical frustum shaped optical lens having a long diameter at a first end and a short diameter at a second end and the conical frustum shaped optical lens defined by multiple rotational surfaces and a flat fifth surface, the multiple rotational surfaces including a first surface, a second surface, a third surface, and a fourth surface; and
a LED chip,
wherein:
the conical frustum shaped optical lens has a cavity located near the second end and defined by the first surface and the second surface for engaging the LED chip;
the first surface is configured such that at least a portion of light striking the first surface from the LED chip is refracted by the first surface onto the flat fifth surface;
the second and third surfaces are configured such that a first portion of light striking the second surface from the LED chip is refracted by the second surface onto the third surface and then reflected by the third surface onto the flat fifth surface; and
the second and fourth surfaces are configured such that a second portion of light striking the second surface from the light source is refracted by the second surface onto the flat fifth surface and then entirely reflected by the flat fifth surface onto the fourth surface and then reflected by the fourth surface back onto the flat fifth surface.

13. The spotlight of claim 12, wherein the lens support has a top surface covered with a reflective coating and the top surface is configured to tightly engage the fourth surface of the conical frustum shaped optical lens.

14. The spotlight of claim 13, wherein the first surface further includes a conical frustum portion and a spherical portion.

15. The spotlight of claim 12, wherein the second surface includes a first multifaceted portion near the bottom of the cavity and the first multifaceted portion is configured to refract, partially, the second portion of the light onto the flat fifth surface at an incidence angle greater than a critical angle between the transparent material and the air.

16. The spotlight of claim 15, wherein the second surface further includes a second multifaceted portion near the opening of the cavity and the second multifaceted portion is configured to refract, partially, the second portion of the light onto the third surface at an incidence angle greater than a critical angle between the transparent material and the air.

17. The spotlight of claim 12, wherein the conical frustum shaped optical lens has a central axis and a horizontal axis that is perpendicular to the central axis, the second surface is configured to satisfy the following constraints:
α>arcsin(sin(α-β)/n)+arcsin(1/n),
wherein β is an angle between a light path within the cavity and the central axis, α is an angle between a trajectory of the surface at a point where the light path strikes the second surface and the horizontal axis, and n is a refraction index of a material forming the conical frustum shaped optical lens.

18. The spotlight of claim 17, wherein the light path within the conical frustum shaped optical lens strikes the flat fifth surface at an angle no less than a critical angle defined by the refraction index of a material forming the conical frustum shaped optical lens.

19. The spotlight of claim 17, wherein the fourth surface is configured to satisfy the following constraints:
-arcsin(sinθ/n)≦2γ-(α-arcsin(sin(α-β)/n))≦arcsin(sinθ/n),
wherein θ is a half of a predefined light beam angle and γ is an angle between a trajectory of the fourth surface at a point where the light path strikes the fourth surface and the horizontal axis.

20. The spotlight of claim 12, wherein the fourth surface is covered with a reflective coating.

21. The spotlight of claim 12, wherein the conical frustum shaped optical lens is made from a UV-resistant transparent material selected from the group consisting of glass and polycarbonate material.

22. The spotlight of claim 12, wherein the spotlight is a multifaceted-reflector (MR) form factor spotlight.
